(19) United States
(12) Patent Application Publication
(10) Pub. No.: US 2016/0035107 A1
(43) Pub. Date: Feb. 4, 2016

(54) MOVING OBJECT DETECTION

(71) Applicants: Wenming ZHENG, Nanjing, Jiangsu (CN); Xu HAN, Nanjing, Jiangsu (CN); Zongcai RUAN, Nanjing, Jiangsu (CN); Yankun ZHANG, (US)

(72) Inventors: Wenming ZHENG, Jiangsu (CN); Xu HAN, Jiangsu (CN); Zongcai RUAN, Jiangsu (CN); Yankun ZHANG, Shanghai (CN)

(21) Appl. No.: 14/773,732

(22) PCT Filed: Apr. 25, 2013
(86) PCT No.: PCT/CN2013/074714

§ 371 Date: Sep. 8, 2015

(51) Int. Cl. G06T 7/20

(52) U.S. Cl. CPC G06T 7/2066; G06T 2207/20016; G06T 2207/30252

(57) ABSTRACT

A method for moving object detection is provided. The method includes: obtaining a first image captured by a monocular camera at a first time point and a second image captured by the monocular camera at a second time point (S101); calculating dense optical flows based on the first and second images (S105); and identifying a moving object based on the calculated dense optical flows (S107 and S109). Since the moving object detection method is based on dense optical flows and the monocular camera, both high detection accuracy and low cost can be achieved.

### TECHNICAL FIELD

The present disclosure generally relates to moving object detection.

### BACKGROUND

Numerous methods for moving object detection are used in driving assistance systems. Some solutions are based on sparse optical flows, which may achieve a relatively fast speed but have a low reliability. That is because mismatches between feature points always occur. Some solutions are based on dense optical flows to improve the robustness. However, expensive stereo cameras are necessary for obtaining dense optical flows. Therefore, a robust but economical method for moving object detection is desired.

### SUMMARY

According to one embodiment of the present disclosure, a method for moving object detection is provided. The method may include: obtaining a first image captured by a monocular camera at a first time point and a second image captured by the monocular camera at a second time point; calculating dense optical flows based on the first and second images; and identifying a moving object based on the calculated dense optical flows. Since the moving object detection method is based on dense optical flow and a monocular camera, both high detection accuracy and low cost can be achieved.

In some embodiments, the dense optical flows may be calculated based on an assumption that the brightness value of a pixel in the first image shall be equal to the brightness value of a corresponding pixel in the second image.

In some embodiments, the dense optical flows may be calculated based on a TV-L1 method.

In some embodiments, the first and second images may be preprocessed before calculating the dense optical flows. In some embodiments, upper parts of the first and second images may be removed, and the dense optical flows may be calculated based on the rest lower parts of the first and second images. In some embodiments, structure-texture decomposition based on a ROF (Rundin, Osher, Fatime) model may be used to preprocess the first and second images. In some embodiments, pyramid restriction may be applied. As a result, efficiency and robustness for illumination changes may be increased.

In some embodiments, identifying the moving object based on the calculated dense optical flows may include: obtaining a third image by coding vector information of the calculated dense optical flows with at least one image feature; and identifying a target block in the third image which has an abrupt change of the at least one image feature compared with other blocks nearby. Static objects may have optical flows which change regularly, while a moving object may have optical flows which change abruptly compared with the optical flows near the moving object. Therefore, the target block representing the moving object may have an abrupt change of the at least one image feature compared with other blocks nearby. Using existing image segmentation algorithms, the target block may be conveniently identified.

In some embodiments, the calculated dense optical flows may have directions coded with hue and lengths coded with color saturation. In some embodiments, the target block may be segmented using image-cut.

According to one embodiment of the present disclosure, a system for moving object detection is provided. The system may include a processing device configured to: obtain a first image captured by a monocular camera at a first time point and a second image captured by the monocular camera at a second time point; calculate dense optical flows based on the first and second images; and identify a moving object based on the calculated dense optical flows.

In some embodiments, the processing device may be configured to calculate the dense optical flows based on an assumption that the brightness value of a pixel in the first image shall be equal to the brightness value of a corresponding pixel in the second image.

In some embodiments, the processing device may be configured to preprocess the first and second images before obtaining the dense optical flows. In some embodiments, upper parts of the first and second images may be removed, and the dense optical flows may be calculated based on the rest lower parts of the first and second images. In some embodiments, structure-texture decomposition based on a ROF (Rundin, Osher, Fatime) model may be used to preprocess the first and second images. In some embodiments, pyramid restriction may be applied. As a result, efficiency and robustness for illumination changes may be increased.

In some embodiments, the processing device may be configured to identify the moving object by: obtaining a third image by coding vector information of the calculated dense optical flows with at least one image feature; and identifying a target block in the third image which has an abrupt change of the at least one image feature compared with other blocks nearby.

In some embodiments, the processing device may be configured to code directions and lengths of the calculated dense optical flows with hue and color saturation, respectively. In some embodiments, the processing device may be configured to segment the target block using image-cut.

According to one embodiment of the present disclosure, a system for moving object detection is provided. The system may include: means for obtaining a first image captured by a monocular camera at a first time point and a second image captured by the monocular camera at a second time point; means for calculating dense optical flows based on the first and second images; and means for identifying a moving object based on the calculated dense optical flows.

According to one embodiment of the present disclosure, a non-transitory computer readable medium, which contains a computer program for moving object detection, is provided. When the computer program is executed by a processor, it will instruct the processor to: obtain a first image captured by a monocular camera at a first time point and a second image captured by the monocular camera at a second time point; calculate dense optical flows based on the first and second images; and identify a moving object based on the calculated dense optical flows.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 schematically illustrates a method 100 for moving object detection according to one embodiment of the present disclosure;

FIG. 2 illustrates a first image captured by a monocular camera at a first time point;

FIG. 3 illustrates a second image captured by the monocular camera at a second time point;

FIG. 4 illustrates a map of dense optical flows calculated based on the first and second images shown in FIGS. 2 and 3; and

FIG. 5 schematically illustrates a color map converted from the dense optical flow map shown in FIG. 4.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

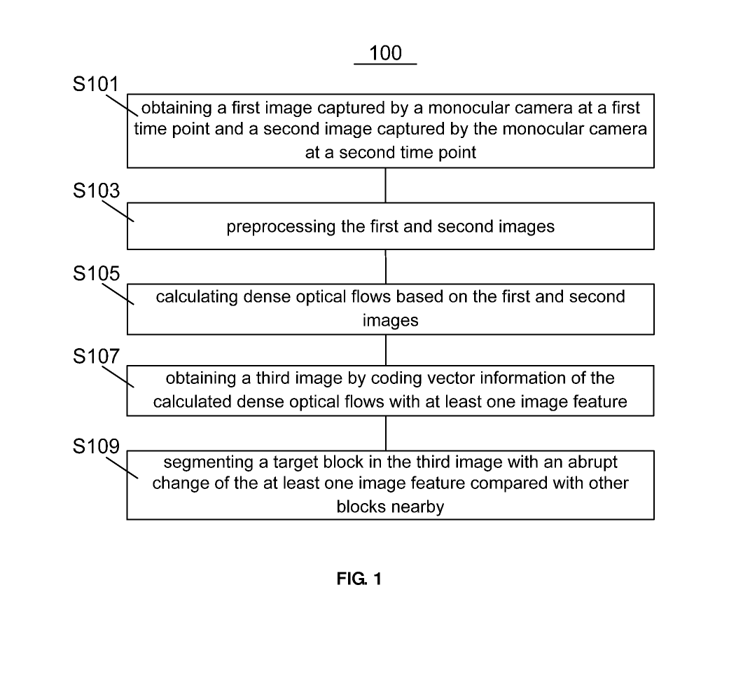

FIG. 1 schematically illustrates a method 100 for moving object detection according to one embodiment of the present disclosure.

Referring to FIG. 1, in S101, obtaining a first image captured by a monocular camera at a first time point and a second image captured by the monocular camera at a second time point.

In some embodiments, the two images may be obtained from a frame sequence captured by the camera. In some embodiments, the two images may be two adjacent frames in the frame sequence. In some embodiments, the two images may be obtained in a predetermined time interval, for example, in every 1/30 second.

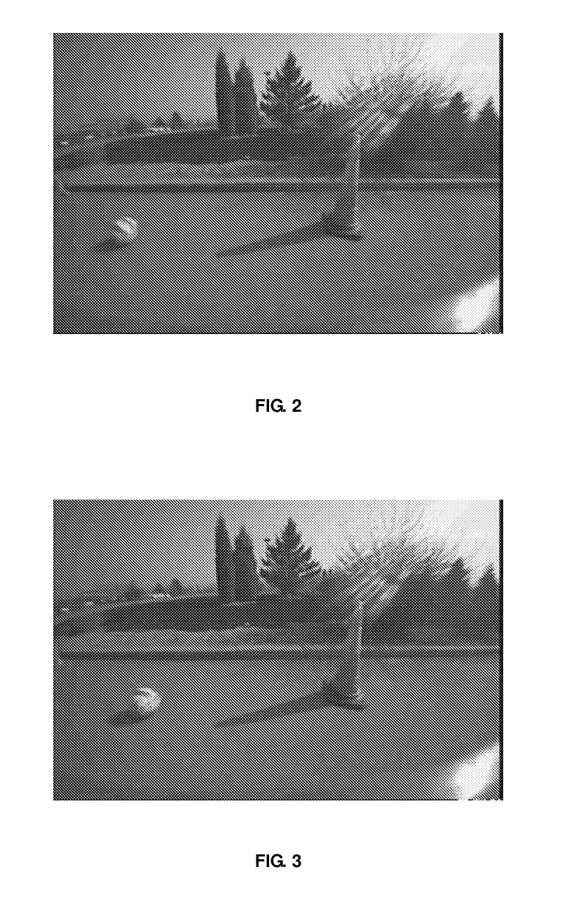

FIGS. 2 and 3 illustrate a first image and a second image captured by a monocular camera at a first time point and a second time point, respectively. The monocular camera may be mounted on a running vehicle, a moving detector, or the like. As shown in FIGS. 2 and 3, static objects including trees, buildings and road may have slight position changes between the two images, while moving objects, e.g., a moving ball, may have more obvious position change.

It could be understood that the slight position changes of the static objects may follow some regulations which are relative to the camera's motion, while position changes of the moving objects may not.

In S103, preprocessing the first and second images.

In some embodiments, structure-texture decomposition based on a ROF (Rundin, Osher, Fatime) model may be applied to preprocess the first and second images to reduce the influence of illumination changes, shading reflections, shadows, and the like. Therefore, the method may be more robust against illumination changes.

In some embodiments, upper parts of the first and second images may be cut off, and following processing may be performed on their rest lower parts. Since moving objects appearing above the vehicle are normally meaningless for the driving, removing the upper parts may improve the efficiency.

In some embodiments, pyramid restriction may be applied. Pyramid restriction, which is also called pyramid representing or image pyramid, may decrease resolution of an original pair of images, i.e., the first and second images. As a result, multiple pairs of images with multiple scales may be obtained. Thereafter, the multiple pairs of images may be subject to the same process as the original pair, and multiple processing results may be approximately fitted, so that the robustness may be further improved.

It should be noted that, there may be other approaches suitable for preprocessing the first and second images, which may be selected based on specific scenarios. S103 may be optional.

In S105, calculating dense optical flows based on the first and second images.

Points may have position changes between the first and second images, thereby generating optical flows. Since the first and second images are captured by the monocular camera, existing methods for calculating dense optical flows using calibration may not be applicable any more. Therefore, in some embodiments of the present disclosure, the dense optical flows may be calculated based on an assumption that the brightness value of a pixel in the first image shall be equal to the brightness value of a corresponding pixel in the second image.

In some embodiments, the dense optical flows may be calculated based on a TV-L1 method. The TV-L1 method establishes an appealing formulation based on total variation (TV) regulation and a robust L1 norm in data fidelity term.

Specifically, the dense optical flows may be calculated by solving Equation (1) to get a minimize E:

E=∫_{Ω}{λ|I₀(x)−I₁(x+u(x))|+|∇u(x)|}dx (1),

where E stands for an energy function, I₀(x) stands for the brightness value of a pixel representing a point having a coordinate x in the first image, I₁(x+u(x)) stands for the brightness value of a corresponding pixel of the point having a coordinate x+u(x) in the second image, u(x) stands for an optical flow of the point from the first image to the second image, ∇u(x) is partial differential for u(x) and λ is a weighting coefficient.

The energy function is separated into two terms. A first term (data term) is also known as an optical flow constraint assuming that a summation of I₀(x) equals to a summation of I₁(x+u(x)), which is a mathematical expression of the assumption described above. A second term (regularization term) penalizes high variations in ∇u(x) to obtain smooth displacement fields.

Linearization and dual-iteration may be adapted for solving Equation (1). Reference of the detail calculation of Equation (1) can be found in “A Duality Based Approach for Realtime TV-L1 Optical Flow” written by C. Zach, T. Pock and H. Bischof, included in “Pattern Recognization and Image Analysis, Third Iberian Conference” published by Springer.

In some embodiments, median filtering may be used to remove outliers of the dense optical flows.

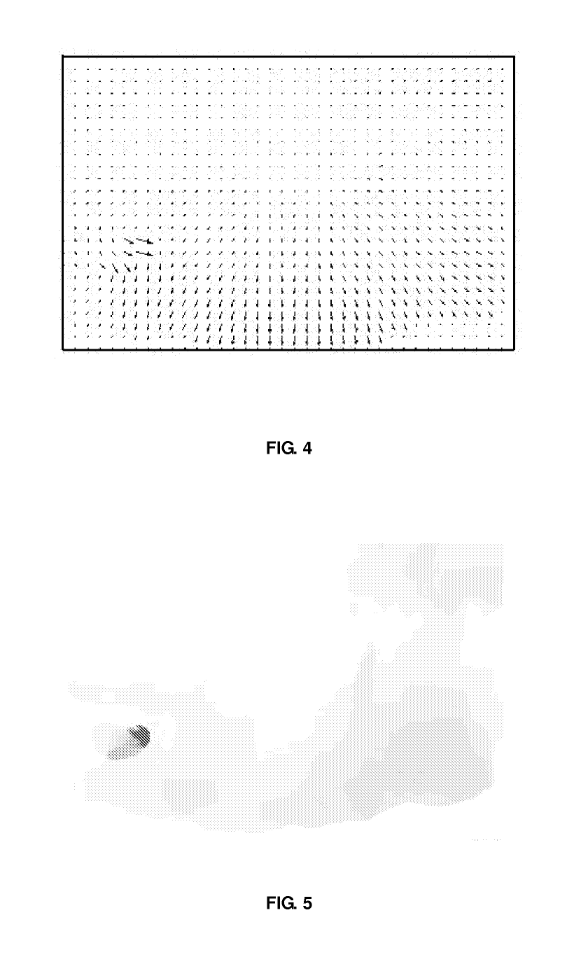

FIG. 4 illustrates a map of dense optical flows calculated based on the first and second images shown in FIGS. 2 and 3. It could be observed that, the static objects may have optical flows which change regularly, while the moving object may have optical flows which change abruptly compared with the optical flows near itself. Therefore, the moving object may be identified by identifying optical flows with abrupt changes.

Hereunder, some exemplary embodiments for identifying the moving object based on the calculated dense optical flow will be illustrated.

In S107, obtaining a third image by coding vector information of the calculated dense optical flows with at least one image feature.

The at least one image feature may include color, grayscale, and the like. In some embodiments, the third image may be obtained using color coding. The calculated dense optical flows may have directions coded with hue and lengths coded with color saturation, so that the third image may be a color map.

FIG. 5 schematically illustrates a color map converted from the dense optical flow map shown in FIG. 4, which is obtained using Middlebury flow benchmark.

With reference to FIGS. 4 and 5, when an optical flow direction changes from upper-left to bottom-left, then to bottom-right and finally to upper-right, the hue reflected in the color map may change from blue to green, then to red and finally to purple. Further, the longer the optical flow is, the higher the saturation may be. As a result, in FIG. 5, a block representing the moving ball, even appearing at the bottom-left corner, is in red as the optical flows thereof are rightward. Further, blocks representing the static objects are light-colored because they only have slight position changes, while the block representing the moving ball is dark-lighted.

In conclusion, the block representing the moving object may have an abrupt change of the at least one image feature compared with other blocks nearby. Therefore, the moving object may be identified by identifying the block with prominent image feature using an image segmentation algorithm.

In S109, segmenting a target block in the third image with an abrupt change of the at least one image feature compared with other blocks nearby.

Image segmentation algorithms are well known in the art, and may not be described in detail here. In some embodiments, image-cut, which may segment a block based on color or grayscale, may be used to segment the target block representing the moving object.

According to one embodiment of the present disclosure, a system for moving object detection is provided. The system may include a processing device configured to: obtain a first image captured by a monocular camera at a first time point and a second image captured by the monocular camera at a second time point; calculate dense optical flows based on the first and second images; and identify a moving object based on the calculated dense optical flows. In some embodiments, the processing device may be configured to preprocess the first and second images before calculating the dense optical flows. Detail information of obtaining the first and second images, preprocessing the first and second images, calculating the dense optical flows and identifying the moving object may be obtained referring to descriptions above, and may not be illustrated in detail here.

According to one embodiment of the present disclosure, a system for moving object detection is provided. The system may include: means for obtaining a first image captured by a monocular camera at a first time point and a second image captured by the monocular camera at a second time point; means for calculating dense optical flows based on the first and second images; and means for identifying a moving object based on the calculated dense optical flows.

According to one embodiment of the present disclosure, a non-transitory computer readable medium, which contains a computer program for moving object detection, is provided. When the computer program is executed by a processor, it will instruct the processor to: obtain a first image captured by a monocular camera at a first time point and a second image captured by the monocular camera at a second time point; calculate dense optical flows based on the first and second images; and identify a moving object based on the calculated dense optical flows.

There is little distinction left between hardware and software implementations of aspects of systems; the use of hardware or software is generally a design choice representing cost vs. efficiency tradeoffs. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for moving object detection, the method comprising:
obtaining a first image captured by a monocular camera at a first time point and a second image captured by the monocular camera at a second time point;
calculating dense optical flows based on the first image and the second image; and
identifying a moving object based on the calculated dense optical flows.

2. The method according to claim 1, wherein the dense optical flows are calculated based on an assumption that the brightness value of a pixel in the first image is equal to the brightness value of a corresponding pixel in the second image.

3. The method according to claim 1, wherein the dense optical flows are calculated based on a TV-L1 method.

4. The method according to claim 1, wherein identifying the moving object based on the calculated dense optical flows comprises:
obtaining a third image by coding vector information of the calculated dense optical flows with at least one image feature; and
identifying a target block in the third image having an abrupt change of the at least one image feature compared with one or more neighboring blocks.

5. The method according to claim 4, wherein the third image is obtained using color coding related to a Middlebury flow benchmark and using image-cut to segment the target block.

6. A system for moving object detection, comprising:
a processing device configured to:
obtain a first image captured by a monocular camera at a first time point and a second image captured by the monocular camera at a second time point;
calculate dense optical flows based on the first image and the second image; and
identify a moving object based on the calculated dense optical flows.

7. The system according to claim 6, wherein the processing device is configured to calculate the dense optical flows based on an assumption that the brightness value of a pixel in the first image is equal to the brightness value of a corresponding pixel in the second image.

8. The system according to claim 6, wherein the processing device is configured to calculate the dense optical flows based on a TV-L1 method.

9. The system according to claim 6, wherein the processing device is configured to identify the moving object based on the calculated dense optical flows by:
obtaining a third image by coding vector information of the calculated dense optical flows with at least one image feature; and
identifying a target block in the third image having an abrupt change of the at least one image feature compared with one or more neighboring blocks.

10. The system according to claim 9, wherein the processing device is configured to obtain the third image by using color coding related to a Middlebury flow benchmark and using image-cut to segment the target block.

11. A system for moving object detection, comprising
means for obtaining a first image captured by a monocular camera at a first time point and a second image captured by the monocular camera at a second time point;
means for calculating dense optical flows based on the first image and the second image; and
means for identifying a moving object based on the calculated dense optical flows.
